(19) United States
(12) Patent Application Publication
(10) Pub. No.: US 2018/0172237 A1
(43) Pub. Date: Jun. 21, 2018

(54) DECORATIVE LIGHTING DEVICE

(71) Applicant: Kuo-Wei Pan, Hsinchu City (TW)

(72) Inventor: Kuo-Wei Pan, Hsinchu City (TW)

(21) Appl. No.: 15/466,513

(22) Filed: Mar. 22, 2017

(30) Foreign Application Priority Data
Dec. 20, 2016 (CN) 201621402052.2

(51) Int. Cl. F21V 5/00; F21S 9/02; F21S 9/03; F21V 21/08; F21V 23/02; F21V 15/01

(52) U.S. Cl. CPC F21V 5/004; F21S 9/02; F21S 9/032; F21W 2121/00; F21V 23/023; F21V 15/01; F21V 21/0824

(57) ABSTRACT

A decorative lighting device, comprising: an illuminating unit; and a light-transparent housing accommodating the illuminating unit, an inner surface of the light-transparent housing having a plurality of optical microstructure elements which refract light emitting from the illuminating unit within an incident angle to emit toward outside of an outer surface of the light transparent housing, the plurality of optical microstructure elements being formed on the inner surface of the light-transparent housing by a position allocation of the optical microstructure elements on the inner surface of the light-transparent housing such that a planar light pattern surrounding the illuminating unit is formed, the optical microstructure elements being provided spreading over the inner surface of the light-transparent housing. Thus, the decorative lighting device of the present invention illuminates special pattern of light.

### TECHNICAL FIELD

The present invention relates to a decorative lighting device.

### BACKGROUND

There are many types of decorative lights used in exterior lighting. A stake light is one typical type of the decorative lights, which is placed on the ground and supported by a ground spike into the ground. The stake light is generally used to provide general illumination or provide accent illumination to a specific object in an outdoor environment such as a garden or a lawn. However, a conventional stake light of the decorative lights usually illuminates light from a general light bulb without generating any special pattern of light. Therefore, it is necessary to provide a decorative lighting device which can illuminate special pattern of light.

### SUMMARY

Accordingly, an object of the present invention is to provide a decorative lighting device, which can illuminate special pattern of light.

To solve the issues in the prior art, the present invention provides a decorative lighting device, comprising: an illuminating unit; and a light-transparent housing accommodating the illuminating unit, an inner surface of the light-transparent housing having a plurality of optical microstructure elements which refract light emitting from the illuminating unit within an incident angle to emit toward outside of an outer surface of the light transparent housing, the plurality of optical microstructure elements are formed on the inner surface of the light-transparent housing by a position allocation of the optical microstructure elements on the inner surface of the light-transparent housing such that a planar light pattern surrounding the illuminating unit is formed, and the optical microstructure elements are provided spreading over the inner surface of the light-transparent housing.

According to an embodiment of the present invention, the decorative lighting device further comprises a supporting rod connected to the light-transparent housing, and the light-transparent housing is a spherical shell.

According to an embodiment of the present invention, the optical microstructure elements protrude inward from the inner surface of the light-transparent housing.

According to an embodiment of the present invention, the plurality of optical microstructure elements is a microlens array, and microlenses in the microlens array are arranged at vertices of equilateral triangles.

According to an embodiment of the present invention, the decorative lighting device further comprises a battery which is electrically connected to the illuminating unit.

According to an embodiment of the present invention, the decorative lighting device further comprises a solar cell which is electrically connected to the illuminating unit.

According to an embodiment of the present invention, the decorative lighting device further comprises a mounting base which is assembled at two opposite through holes of the light-transparent housing and accommodates the battery, and the illuminating unit is disposed at an outside of the mounting base.

According to an embodiment of the present invention, the decorative lighting device further comprises a switching element which is electrically connected to the illuminating unit for switching lighting modes of the illuminating unit.

By the technical means adopted by the present invention, the light emitting from illuminating units are refracted through a plurality of optical microstructure elements to form planar light patterns at the position of each of the illuminating units. Each planar light pattern is formed by taking one illuminating unit as its center. Thus, the decorative lighting device of the present invention illuminates special pattern of light.

### BRIEF DESCRIPTION OF THE DRAWINGS

FIG. 1 is a perspective view of a decorative lighting device according to a first embodiment of the present invention;

FIG. 2 is a schematic diagram of position allocation of a plurality of optical microstructure elements according to the first embodiment of the present invention;

FIG. 3 is a diagram of appearance of the decorative lighting device in use according to the first embodiment of the present invention;

FIG. 4 is a cross-section view of the decorative lighting device according to the first embodiment of the present invention;

FIG. 5 is a perspective view of the decorative lighting device according to a second embodiment of the present invention.

### DETAILED DESCRIPTION OF THE PREFERRED EMBODIMENTS

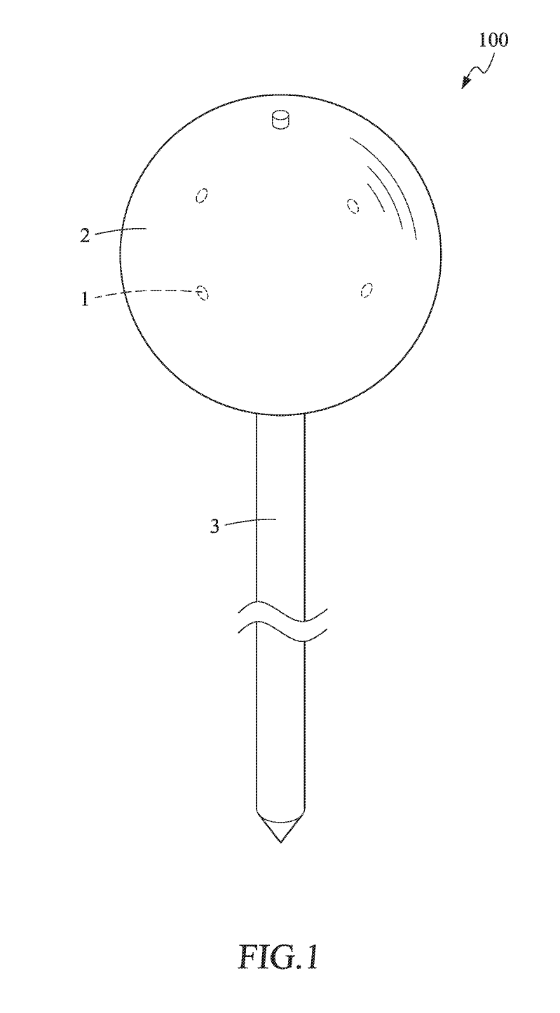

The preferred embodiments of the present invention are described in detail below with reference to FIG. 1 to FIG. 5. The description is used for explaining the embodiments of the present invention only, but not for limiting the scope of the claims.

As shown in FIG. 1 to FIG. 4, a decorative lighting device 100 according to the first embodiment of the present invention includes: an illuminating unit 1; a light-transparent housing 2 accommodating the illuminating unit 1, an inner surface of the light-transparent housing 2 having a plurality of optical microstructure elements 21 which refract light emitting from the illuminating unit 1 within an incident angle to emit toward outside of an outer surface of the light transparent housing 2, the plurality of optical microstructure elements 21 being formed on the inner surface of the light-transparent housing 2 by a position allocation such that a planar light pattern L surrounding the illuminating unit 1 is formed, and the optical microstructure elements 21 are provided spreading over the inner surface of the light-transparent housing 2; and a supporting rod 3 connected to the light-transparent housing 2.

Specifically, the illuminating unit 1 is a point light source. In this embodiment, the illuminating units 1 are multiple LEDs which are spaced apart from each other and refracted through the plurality of optical microstructure elements 21 to generate a visual effect of multiple planar light patterns L.

As shown in FIG. 1, in the decorative lighting device 100 according to the first embodiment of the present invention, the light-transparent housing 2 is a spherical shell. The multiple LEDs are disposed in the spherical shell and separated from the inner surface of the spherical shell. It goes without saying that the invention is not limited to this. In other embodiments, shape of the light-transparent housing 2 can be cuboid, cone-shaped, or prismatic, etc.

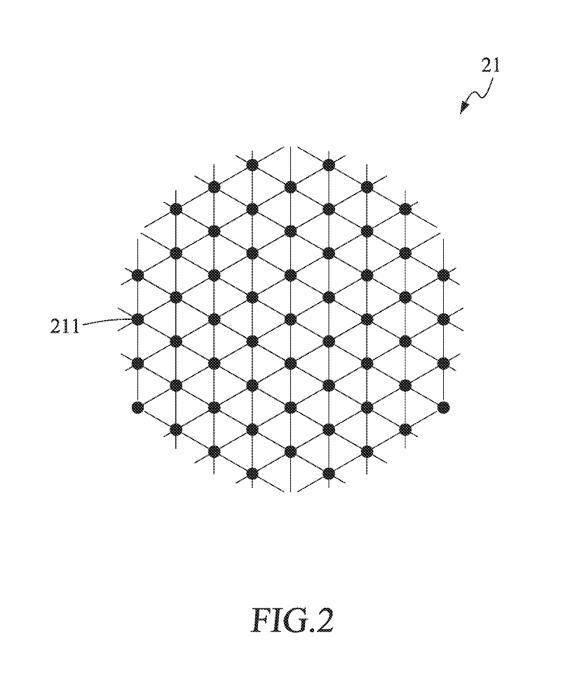

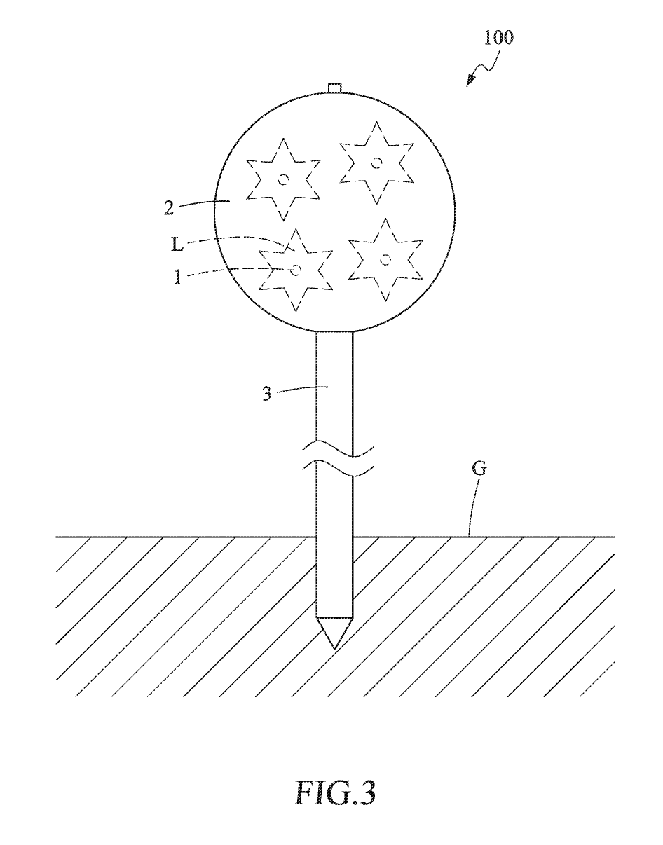

The plurality of optical microstructure elements 21 is a microlens array, and microlenses 211 in the microlens array are cone-shaped microlenses or frustum-shaped microlenses, which protrude inward from the inner surface of the light-transparent housing 2. The height of the microlenses is less than 1 mm and the microlenses are spaced from each other. Outer surface of the light-transparent housing 2 is a smooth surface. In this embodiment, the microlenses 211 are tetrahedrons which are arranged at vertices of equilateral triangles as shown in FIG. 2, and generate a visual effect of star-shaped planar light patterns as shown in FIG. 3. The planar light patterns L are formed in the light-transparent housing 2 with each illuminating unit 1 being at the center, where in the shape of each planar light patterns L is a hexagram. In other embodiments, the microlenses 211 can be frustum-shaped microlenses or other cone-shaped microlenses, or arranged in other ways to change the shape of the planar light pattern.

An upper end of the supporting rod 3 is connected to the light-transparent housing 2. And a lower end of the supporting rod 3 is a spike for inserting into the ground to enable the decorative lighting device 100 to stand upright.

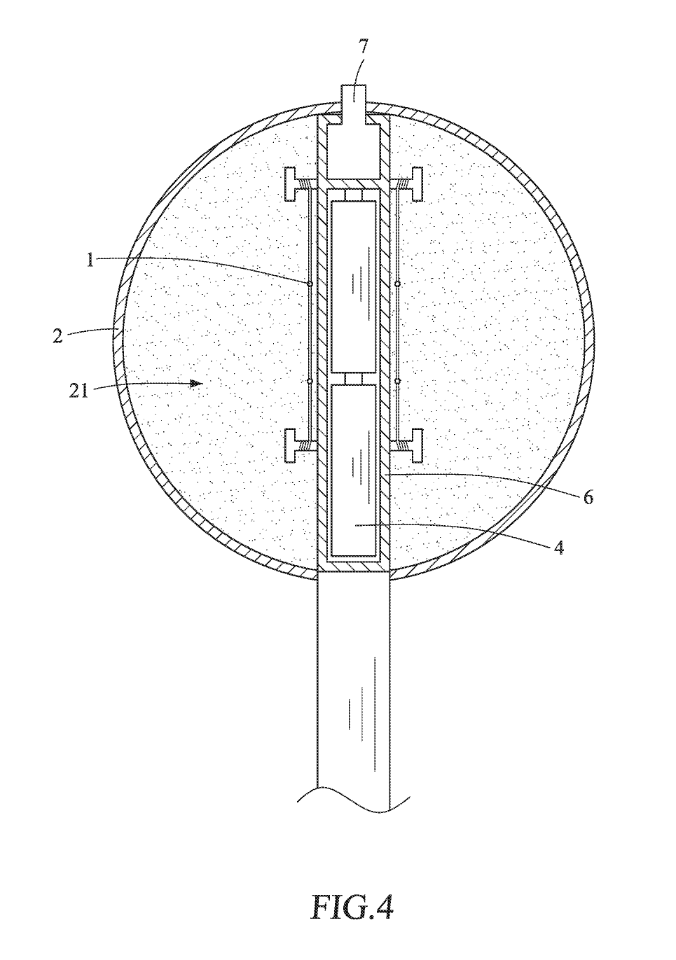

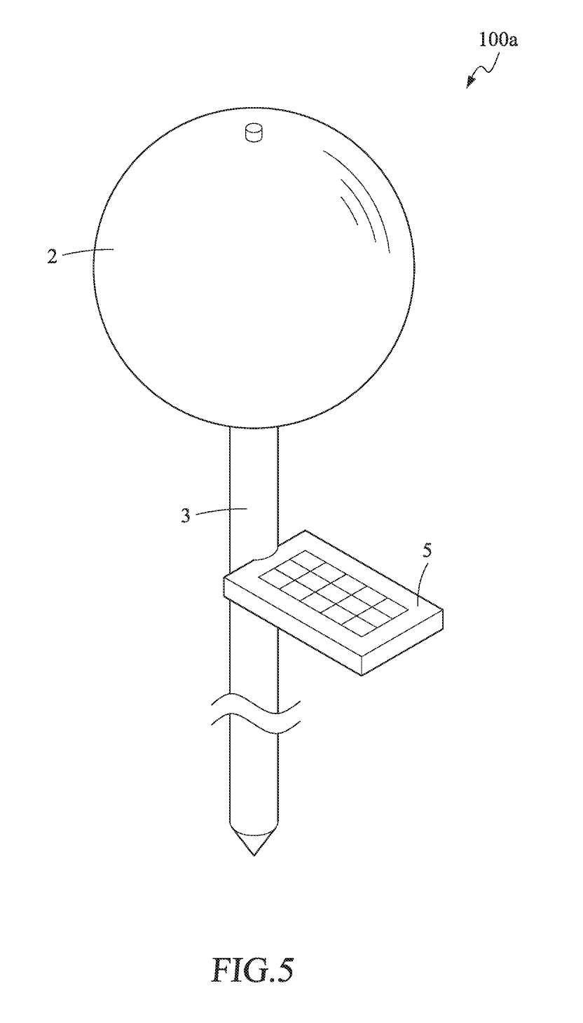

As shown in FIG. 4, in the decorative lighting device 100 according to the first embodiment of the present invention, a mounting base 6 is assembled at two opposite through holes of the light-transparent housing 2 and accommodates the battery 4. The illuminating unit 1 is disposed at an outside of the mounting base 6. The battery 4 is electrically connected to the illuminating unit 1 to provide required energy of the illuminating unit1 1. It goes without saying that the required power of the illuminating unit 1 can be acquired other ways. As s shown in FIG. 5, in the decorative lighting device 100a according to the second embodiment of the present invention, a solar cell 5 which is electrically connected to the illuminating unit 1 provides the required power of the illuminating unit 1. The solar cell 5 is disposed at the supporting rod 3.

As shown in FIG. 4, in the decorative lighting device 100 according to the first embodiment of the present invention, a switching element 7 is electrically connected to the illuminating unit 1 for switching lighting modes of the illuminating unit 1. The lighting modes include constant-lighting mode and sparkling mode for a user to choose, which provide various visual effects of planar light pattern L.

The above description should be considered as only the discussion of the preferred embodiments of the present invention. A person having ordinary skill in the art may make various modifications to the present invention. However, those modifications still fall within the spirit of the present invention and the scope defined by the appended claims.

1. A decorative lighting device, comprising:
an illuminating unit; and
a light-transparent housing accommodating the illuminating unit, an inner surface of the light-transparent housing having a plurality of optical microstructure elements which refract light emitting from the illuminating unit within an incident angle to emit toward outside of an outer surface of the light transparent housing, the plurality of optical microstructure elements are formed on the inner surface of the light-transparent housing by a position allocation of the optical microstructure elements on the inner surface of the light-transparent housing such that one planar light pattern corresponds to one illuminating unit, each planar light pattern is formed surrounding the corresponding illuminating unit and each planar light pattern is formed inside of the light-transparent housing, and the optical microstructure elements are provided spreading over the inner surface of the light-transparent housing.

2. The decorative lighting device as claimed in claim 1, further comprising a supporting rod connected to the light-transparent housing, and the light-transparent housing is a spherical shell.

3. The decorative lighting device as claimed in claim 1, wherein the optical microstructure elements protrude inward from the inner surface of the light-transparent housing.

4. The decorative lighting device as claimed in claim 1, wherein the optical microstructure elements are cone-shaped microlenses or frustum-shaped microlenses.

5. The decorative lighting device as claimed in claim 1, wherein the plurality of optical microstructure elements is a microlens array, and microlenses in the microlens array are arranged at vertices of equilateral triangles.

6. The decorative lighting device as claimed in claim 1, further comprising a battery which is electrically connected to the illuminating unit.

7. The decorative lighting device as claimed in claim 1, further comprising a solar cell which is electrically connected to the illuminating unit.

8. The decorative lighting device as claimed in claim 6, further comprising a mounting base which is assembled at two opposite through holes of the light-transparent housing and accommodates the battery, and the illuminating unit is disposed at an outside of the mounting base.

9. The decorative lighting device as claimed in claim 1, further comprising a switching element which is electrically connected to the illuminating unit for switching lighting modes of the illuminating unit.
